(19) United States
(12) Patent Application Publication
(10) Pub. No.: US 2020/0107228 A1
(43) Pub. Date: Apr. 2, 2020

(54) Fast Data-Rate Scaling

(71) Applicant: Google LLC, Mountain View, CA (US)

(72) Inventors: Jibing Wang, Saratoga, CA (US); Erik Richard Stauffer, Sunnyvale, CA (US)

(73) Assignee: Google LLC, Mountain View, CA (US)

(21) Appl. No.: 16/148,428

(22) Filed: Oct. 1, 2018

(51) Int. Cl. H04W 28/22; H04W 74/08; H04W 72/14; H04W 72/12

(52) U.S. Cl. CPC H04W 28/22; H04W 74/0833; H04W 92/20; H04W 72/1284; H04W 72/14

(57) ABSTRACT

This document describes techniques that enable fast data-rate scaling. Using the described techniques, a user equipment (110) can detect trigger events that may be addressed by a data rate adjustment (402). In response to the trigger event, the user equipment can determine a data-rate scaling factor (404). The user equipment can transmit the data-rate scaling factor to a base station (120) that is providing a data rate negotiated between the user equipment and the base station and cause the base station to provide an adjusted data rate that is based at least in part on the data-rate scaling factor (406). When the data-rate scaling factor is transmitted via a Random Access Channel or a Physical Random Access Channel, the user equipment may adjust the data rate without waiting for an uplink grant, which can enable the user equipment to quickly mitigate operating conditions such as low battery capacity.

### BACKGROUND

The evolution of wireless communication to fifth generation (5G) standards and technologies provides higher data rates and greater capacity, with improved reliability and lower latency, which enhances mobile broadband services. 5G technologies also provide new classes of services for vehicular networking, fixed wireless broadband, and the Internet of Things (IoT).

A unified air interface, which utilizes licensed, unlicensed, and shared license radio spectrum in multiple frequency bands, is one aspect of enabling the capabilities of 5G systems. The 5G air interface utilizes radio spectrum in bands below 1 GHz (sub-gigahertz), below 6 GHz (sub-6 GHz), and above 6 GHz. Radio spectrum above 6 GHz includes millimeter wave (mmWave) frequency bands that provide wide channel bandwidths to support higher data rates for wireless broadband. Another aspect of enabling the capabilities of 5G systems is the use of Multiple Input Multiple Output (MIMO) antenna systems to beamform signals transmitted between base stations and user equipment to increase the capacity of 5G radio networks.

5G networks enable higher data-transfer rates, compared to existing networks. These higher data rates may cause the user equipment to operate at higher temperatures and consume more power relative to operation on conventional networks. Conventional techniques for managing thermal conditions and power consumption of the user equipment may rely on upper layer control-plane signaling to negotiate between the user equipment and the base station. In some cases, however, it is critical to mitigate thermal and power management issues quickly, and the overhead to establish an uplink connection for control-plane signaling may adversely affect the user equipment.

### SUMMARY

This document describes techniques and systems that enable fast data-rate scaling. The techniques and systems use a data-rate scaling factor to adjust a data rate provided to a user equipment by a base station. The user equipment can detect trigger events that indicate the user equipment may be in a state or condition that can be mitigated by a data rate adjustment. The user equipment can transmit the data-rate scaling factor to the base station via a Random Access Channel (RACH) or a Physical Random Access Channel (PRACH). These techniques allow the user equipment to adjust the data rate without waiting for an uplink grant, which can enable the user equipment to quickly mitigate adverse operating condition such as low battery capacity or excessive temperature.

In some aspects, a method for adjusting a data rate at which a user equipment (UE) is operating is described. The method comprises detecting a trigger event and, in response to the trigger event, determining a data-rate scaling factor. The method further includes transmitting the data-rate scaling factor to a base station that is providing the data rate negotiated between the UE and the base station. The transmitting is effective to cause the base station to provide an adjusted data rate that is based at least in part on the data-rate scaling factor.

In other aspects, a user equipment (UE) is described that includes a radio frequency (RF) transceiver and a processor and memory system to implement a data-rate manager application. The data-rate manager application is configured to detect a trigger event and, in response to the trigger event, determine a data-rate scaling factor for an operating data rate. Further, the data-rate manager application transmits the data-rate scaling factor to the base station, using the RF transceiver, and causes the UE to operate at an adjusted data rate that is provided by the base station and based, at least in part, on the data-rate scaling factor.

In further aspects, a base station is described that includes a radio frequency (RF) transceiver and a processor and memory system to implement a resource manager application. The resource manager application negotiates a data rate with a user equipment (UE) and provides the data rate to the UE. The resource manager application also receives a data-rate scaling factor from the UE. Based at least in part on the data-rate scaling factor, the resource manager application determines an adjusted data rate and provides the adjusted data rate to the UE, which is effective to cause the UE to operate at the adjusted data rate.

In other aspects, a user equipment (UE) is described that includes a radio frequency (RF) transceiver and a processor and memory system. The UE further includes a means to detect a trigger event and, in response to the trigger event, determine a data-rate scaling factor for an operating data rate. The UE also includes a means to transmit the data-rate scaling factor to the base station, using the RF transceiver, and cause the UE to operate at an adjusted data rate that is provided by the base station and based, at least in part, on the data-rate scaling factor.

This summary is provided to introduce simplified concepts of fast data-rate scaling. The simplified concepts are further described below in the Detailed Description. This summary is not intended to identify essential features of the claimed subject matter, nor is it intended for use in determining the scope of the claimed subject matter.

### BRIEF DESCRIPTION OF THE DRAWINGS

Aspects of fast data-rate scaling are described with reference to the following drawings. The same numbers are used throughout the drawings to reference like features and components:

FIG. 1 illustrates an example environment in which various aspects of fast data-rate scaling can be implemented.

FIG. 2 illustrates an example device diagram that can implement various aspects of fast data-rate scaling.

FIG. 3 illustrates an air interface resource that extends between a user equipment and a base station and with which various aspects of fast data-rate scaling can be implemented.

FIG. 4 illustrates an example method for fast data-rate scaling as generally related to adjusting, based on an occurrence of a trigger event, a data rate the base stations provide to the user equipment using a data-rate scaling factor in accordance with aspects of the techniques described herein.

FIG. 5 illustrates an example method for fast data-rate scaling as generally related to adjusting, based on a prediction of a trigger event occurring, a data rate the base stations provide to the user equipment using a data-rate scaling factor in accordance with aspects of the techniques described herein.

FIG. 6 illustrates additional details of the method described in FIG. 5.

FIG. 7 illustrates additional details of the method described in FIG. 5.

### DETAILED DESCRIPTION

Overview

This document describes techniques using, and devices enabling, fast data-rate scaling. As noted, fifth-generation new radio (5G NR) networks enable larger amounts of data to be transferred at higher data rates, as compared to existing wireless networks. The higher data rate may cause the user equipment to operate at higher temperatures and consume more power relative to operation on conventional networks. The user equipment can typically support the higher data rate provided by 5G NR connections when the data is transmitted over short durations, such as tens or hundreds of milliseconds or a few seconds. Sometimes, however, constraints of the user equipment may not allow it to sustain the higher throughput for long durations (e.g., a few minutes, tens of minutes, and so forth). The user equipment may request to adjust the data rate by requesting a lower-frequency carrier or reducing the number of antenna elements used in multiple-input and multiple-output (MIMO) configurations, and so forth. These techniques have potential to adversely affect network efficiency (including resource utilization, spectral efficiency, and/or spatial efficiency). Further, conventional techniques often rely on uplink or other message channels that require negotiation between the user equipment and the base station. In some cases, however, it is critical to mitigate thermal and power management issues quickly, and the delay to establish an uplink connection may adversely affect the user equipment.

In contrast, the described techniques allow a user equipment to send a data-rate scaling factor to a base station. Based on the data-rate scaling factor, the base station adjusts the data rate provided to the user equipment. The user equipment may send the data-rate scaling factor to the base station in response to a trigger event, such as a battery-capacity threshold or a thermal parameter threshold. The data-rate scaling factor can be transmitted to the base station using a variety of lower layer connections, including a Random Access Channel (RACH) or a Physical Random Access Channel (PRACH), which allow the data-rate scaling factor to be transmitted without an uplink grant. Thus, the user equipment can take advantage of the data-rate scaling factor to dynamically change the data rate at which it is operating. In this way, the user equipment can address thermal and battery-capacity challenges without adversely affecting network resource utilization efficiency or consuming unneeded network resources that can be used by other devices on the network.

Consider, for example, a user equipment operating at a higher data rate while running an application that has an asymmetry of uplink and downlink data traffic in which the downlink data is much greater that the uplink traffic, such as web browsing or video streaming. As the data rate remains high and time passes, the operating temperature of the user equipment may increase and the remaining battery capacity may decrease. When the temperature or battery capacity reaches a critical level, the user equipment may request a lower data rate from the base station to which it is connected. Using conventional techniques, the user equipment and the network can experience efficiency problems and may have to wait for an uplink grant to transmit the request, which could result in the battery running out of power, battery safety shut-off (e.g., if the battery reaches a threshold temperature), or damage to user equipment caused by prolonged heat. In contrast, using the described techniques and devices that implement fast data-rate scaling, the user equipment can transmit the data-rate scaling factor to the base station without waiting for an uplink grant. This can allow the user equipment to continue operating within a specified operating temperature range and preserve battery capacity.

While features and concepts of the described systems and methods for fast data-rate scaling can be implemented in any number of different environments, systems, devices, and/or various configurations, aspects of fast data-rate scaling are described in the context of the following example devices, systems, and configurations.

### Example Environment

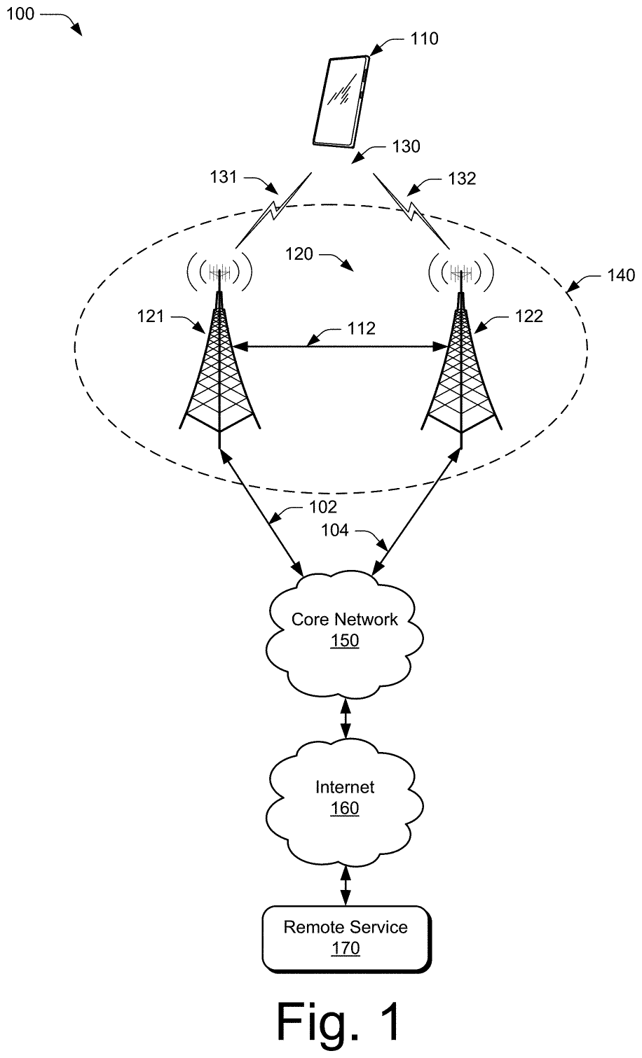

FIG. 1 illustrates an example environment 100 in which various aspects of fast data-rate scaling can be implemented. The example environment 100 includes a user equipment 110 that communicates with one or more base stations 120 (illustrated as base stations 121 and 122), through one or more wireless communication links 130 (wireless link 130), illustrated as wireless links 131 and 132. In this example, the user equipment 110 is implemented as a smartphone. Although illustrated as a smartphone, the user equipment 110 may be implemented as any suitable computing or electronic device, such as a mobile communication device, a modem, cellular phone, gaming device, navigation device, media device, laptop computer, desktop computer, tablet computer, smart appliance, or vehicle-based communication system. The base stations 120 (e.g., an Evolved Universal Terrestrial Radio Access Network Node B, E-UTRAN Node B, evolved Node B, eNodeB, eNB, Next Generation Node B, gNode B, gNB, or the like) may be implemented in a macrocell, microcell, small cell, picocell, and the like, or any combination thereof.

The base stations 120 communicate with the user equipment 110 via the wireless links 131 and 132, which may be implemented as any suitable type of wireless link. The wireless links 131 and 132 can include a downlink of data and control information communicated from the base stations 120 to the user equipment 110, an uplink of other data and control information communicated from the user equipment 110 to the base stations 120, or both. The wireless links 130 may include one or more wireless links or bearers implemented using any suitable communication protocol or standard, or combination of communication protocols or standards such as 3rd Generation Partnership Project Long-Term Evolution (3GPP LTE), Fifth Generation New Radio (5G NR), and so forth. Multiple wireless links 130 may be aggregated in a carrier aggregation to provide a higher data rate for the user equipment 110. Multiple wireless links 130 from multiple base stations 120 may be configured for Coordinated Multipoint (CoMP) communication with the user equipment 110.

The base stations 120 are collectively a Radio Access Network 140 (RAN, Evolved Universal Terrestrial Radio Access Network, E-UTRAN, 5G NR RAN or NR RAN). The base stations 121 and 122 in the RAN 140 are connected to a Fifth Generation Core 150 (5GC 150) network. The base stations 121 and 122 connect, at 102 and 104 respectively, to the 5GC 150 via an NG2 interface for control-plane signaling and via an NG3 interface for user-plane data communications. In addition to connections to core networks, base stations 120 may communicate with each other via an Xn Application Protocol (XnAP), at 112, to exchange user-plane and control-plane data. The user equipment 110 may also connect, via the 5GC 150, to public networks, such as the Internet 160 to interact with a remote service 170.

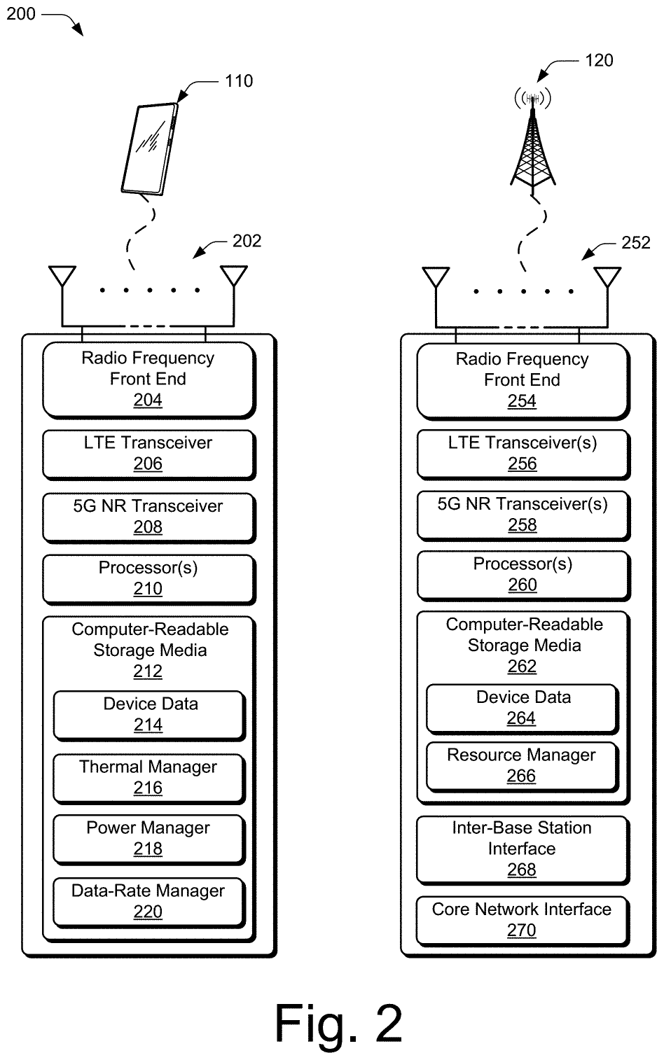

FIG. 2 illustrates an example device diagram 200 of the user equipment 110 and the base stations 120. The user equipment 110 and the base stations 120 may include additional functions and interfaces that are omitted from FIG. 2 for the sake of clarity. The user equipment 110 includes antennas 202, a radio frequency front end 204 (RF front end 204), an LTE transceiver 206, and a 5G NR transceiver 208 for communicating with base stations 120 in the RAN 140. The RF front end 204 of the user equipment 110 can couple or connect the LTE transceiver 206, and the 5G NR transceiver 208 to the antennas 202 to facilitate various types of wireless communication. The antennas 202 of the user equipment 110 may include an array of multiple antennas that are configured similar to or differently from each other. The antennas 202 and the RF front end 204 can be tuned to, and/or be tunable to, one or more frequency bands defined by the 3GPP LTE and 5G NR communication standards and implemented by the LTE transceiver 206, and/or the 5G NR transceiver 208. Additionally, the antennas 202, the RF front end 204, the LTE transceiver 206, and/or the 5G NR transceiver 208 may be configured to support beamforming for the transmission and reception of communications with the base stations 120. By way of example and not limitation, the antennas 202 and the RF front end 204 can be implemented for operation in sub-gigahertz bands, sub-6 GHZ bands, and/or above 6 GHz bands that are defined by the 3GPP LTE and 5G NR communication standards.

The user equipment 110 also includes processor(s) 210 and computer-readable storage media 212 (CRM 212). The processor 210 may be a single core processor or a multiple core processor composed of a variety of materials, such as silicon, polysilicon, high-K dielectric, copper, and so on. The computer-readable storage media described herein excludes propagating signals. CRM 212 may include any suitable memory or storage device such as random-access memory (RAM), static RAM (SRAM), dynamic RAM (DRAM), non-volatile RAM (NVRAM), read-only memory (ROM), or Flash memory useable to store device data 214 of the user equipment 110. The device data 214 includes user data, multimedia data, beamforming codebooks, applications, and/or an operating system of the user equipment 110, which are executable by processor(s) 210 to enable user-plane communication, control-plane signaling, and user interaction with the user equipment 110.

In some implementations, the CRM 212 may also include either or both of a thermal manager 216 and a power manager 218. The thermal manager 216 can communicate with one or more thermal sensors (e.g., a thermistor or other temperature or heat sensor), in or associated with the user equipment 110, which measure temperature and other thermal properties of the user equipment 110 (including individual measurements of various components of the user equipment 110). The thermal manager 216 can store and transmit values of the measurements to other components of the user equipment 110 or to other devices.

The power manager 218 can monitor a battery (or batteries) of the user equipment 110. The power manager 218 can also measure, store, and communicate values of various power-related parameters of the user equipment 110 (e.g., remaining battery capacity) to other components of the user equipment 110 or to other devices. Further, while both are shown as part of the CRM 212 in FIG. 2, either or both of the thermal manager 216 and the power manager 218 may be implemented in whole or part as hardware logic or circuitry integrated with or separate from other components of the user equipment 110.

CRM 212 also includes a data-rate manager 220. Alternately or additionally, the data-rate manager 220 may be implemented in whole or part as hardware logic or circuitry integrated with or separate from other components of the user equipment 110. In at least some aspects, the data-rate manager 220 configures the RF front end 204, the LTE transceiver 206, and/or the 5G NR transceiver 208 to implement the techniques for fast data-rate scaling described herein. For example, the data-rate manager 220 may negotiate with the base stations 120 to determine a data rate and then cause the user equipment 110 to operate at the negotiated data rate. The data-rate manager 220 can also detect a trigger event and, in response to the trigger event, determine a data-rate scaling factor. In some cases, the data-rate manager 220 may detect the trigger event by communicating with either or both of the thermal manager 216 and the power manager 218. Further, the data-rate manager 220 may also transmit the data-rate scaling factor to the base station 120 and cause the user equipment 110 to operate at an adjusted data rate provided by the base stations 120.

The device diagram for the base stations 120, shown in FIG. 2, includes a single network node (e.g., a gNode B). The functionality of the base stations 120 may be distributed across multiple network nodes or devices and may be distributed in any fashion suitable to perform the functions described herein. The base stations 120 include antennas 252, a radio frequency front end 254 (RF front end 254), one or more LTE transceivers 256, and/or one or more 5G NR transceivers 258 for communicating with the user equipment 110. The RF front end 254 of the base stations 120 can couple or connect the LTE transceivers 256 and the 5G NR transceivers 258 to the antennas 252 to facilitate various types of wireless communication. The antennas 252 of the base stations 120 may include an array of multiple antennas that are configured similar to or differently from each other. The antennas 252 and the RF front end 254 can be tuned to, and/or be tunable to, one or more frequency band defined by the 3GPP LTE and 5G NR communication standards, and implemented by the LTE transceivers 256, and/or the 5G NR transceivers 258. Additionally, the antennas 252, the RF front end 254, the LTE transceivers 256, and/or the 5G NR transceivers 258 may be configured to support beamforming, such as Massive-MIMO, for the transmission and reception of communications with the user equipment 110.

The base stations 120 also include processor(s) 260 and computer-readable storage media 262 (CRM 262). The processor 260 may be a single core processor or a multiple core processor composed of a variety of materials, such as silicon, polysilicon, high-K dielectric, copper, and so on. CRM 262 may include any suitable memory or storage device such as random-access memory (RAM), static RAM (SRAM), dynamic RAM (DRAM), non-volatile RAM (NVRAM), read-only memory (ROM), or Flash memory useable to store device data 264 of the base stations 120. The CRM 262 may exclude propagating signals. The device data 264 includes network scheduling data, radio resource management data, beamforming codebooks, applications, and/or an operating system of the base stations 120, which are executable by processor(s) 260 to enable communication with the user equipment 110.

CRM 262 also includes a resource manager 266. Alternately or additionally, the resource manager 266 may be implemented in whole or part as hardware logic or circuitry integrated with or separate from other components of the base stations 120. In at least some aspects, the resource manager 266 configures the LTE transceivers 256 and the 5G NR transceivers 258 for communication with the user equipment 110, as well as communication with a core network, such as the 5GC 150. Additionally, the resource manager 266 may negotiate with the user equipment 110 to determine a data rate that the base stations 120 provide to the user equipment 110. The resource manager 266 may also receive the data-rate scaling factor from the user equipment 110. Based on the data-rate scaling factor, the resource manager 266 may determine an adjusted data rate and provide the adjusted data rate to the user equipment 110.

The base stations 120 include an inter-base station interface 268, such as an Xn and/or X2 interface, which the resource manager 266 configures to exchange user-plane and control-plane data between other base stations 120, to manage the communication of the base stations 120 with the user equipment 110. The base stations 120 include a core network interface 270 that the resource manager 266 configures to exchange user-plane and control-plane data with core network functions and entities.

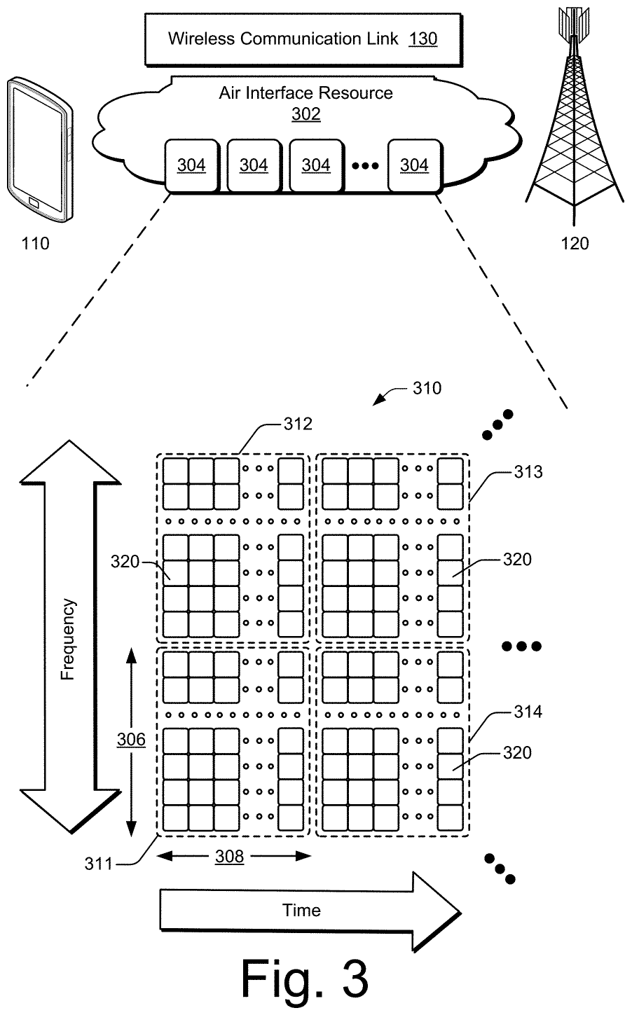

FIG. 3 illustrates an air interface resource that extends between a user equipment and a base station and with which various aspects of fast data-rate scaling can be implemented. The air interface resource 302 can be divided into resource units 304, each of which occupies some intersection of frequency spectrum and elapsed time. A portion of the air interface resource 302 is illustrated graphically in a grid or matrix having multiple resource blocks 310, including example resource blocks 311, 312, 313, 314. An example of a resource unit 304 therefore includes at least one resource block 310. As shown, time is depicted along the horizontal dimension as the abscissa axis, and frequency is depicted along the vertical dimension as the ordinate axis. The air interface resource 302, as defined by a given communication protocol or standard, may span any suitable specified frequency range, and/or may be divided into intervals of any specified duration. Increments of time can correspond to, for example, milliseconds (mSec). Increments of frequency can correspond to, for example, megahertz (MHz).

In example operations generally, the base stations 120 allocate portions (e.g., resource units 304) of the air interface resource 302 for uplink and downlink communications. Each resource block 310 of network access resources may be allocated to support respective wireless communication links 130 of multiple user equipment 110. In the lower left corner of the grid, the resource block 311 may span, as defined by a given communication protocol, a specified frequency range 306 and comprise multiple subcarriers or frequency sub-bands. The resource block 311 may include any suitable number of subcarriers (e.g., 12) that each correspond to a respective portion (e.g., 15 kHz) of the specified frequency range 306 (e.g., 180 kHz). The resource block 311 may also span, as defined by the given communication protocol, a specified time interval 308 or time slot (e.g., lasting approximately one-half millisecond or 7 orthogonal frequency-division multiplexing (OFDM) symbols). The time interval 308 includes subintervals that may each correspond to a symbol, such as an OFDM symbol. As shown in FIG. 3, each resource block 310 may include multiple resource elements 320 (REs) that correspond to, or are defined by, a subcarrier of the frequency range 306 and a subinterval (or symbol) of the time interval 308. Alternatively, a given resource element 320 may span more than one frequency subcarrier or symbol. Thus, a resource unit 304 may include at least one resource block 310, at least one resource element 320, and so forth.

In example implementations, multiple user equipment 110 (one of which is shown) are communicating with the base stations 120 (one of which is shown) through access provided by portions of the air interface resource 302. The resource manager 266 (shown in FIG. 2) may determine a respective data-rate, type of information, or amount of information (e.g., data or control information) to be communicated (e.g., transmitted) by the user equipment 110. For example, the resource manager 266 can determine that each user equipment 110 is to transmit at a different respective data rate (e.g., based on a data-rate scaling factor, as described herein) or transmit a different respective amount of information. The resource manager 266 then allocates one or more resource blocks 310 to each user equipment 110 based on the determined data rate or amount of information. The air interface resource 302 can also be used to transmit the data-rate scaling factor, as described herein.

Additionally or in the alternative to block-level resource grants, the resource manager 266 may allocate resource units at an element-level. Thus, the resource manager 266 may allocate one or more resource elements 320 or individual subcarriers to different user equipment 110. By so doing, one resource block 310 can be allocated to facilitate network access for multiple user equipment 110. Accordingly, the resource manager 266 may allocate, at various granularities, one or up to all subcarriers or resource elements 320 of a resource block 310 to one user equipment 110 or divided across multiple user equipment 110, thereby enabling higher network utilization or increased spectrum efficiency. Additionally or alternatively, the resource manager 266 may, in response to the data-rate scaling factor described herein, reallocate or change the allocation of air interface resources for a carrier, subcarrier, or carrier band.

The resource manager 266 can therefore allocate air interface resource 302 by resource unit 304, resource block 310, frequency carrier, time interval, resource element 320, frequency subcarrier, time subinterval, symbol, spreading code, some combination thereof, and so forth. Based on respective allocations of resource units 304, the resource manager 266 can transmit respective messages to the multiple user equipment 110 indicating the respective allocation of resource units 304 to each user equipment 110. Each message may enable a respective user equipment 110 to queue the information or configure the LTE transceiver 206, the 5G NR transceiver 208, or both to communicate via the allocated resource units 304 of the air interface resource 302.

Fast Data-Rate Scaling

In aspects, the user equipment 110 operates at a data rate negotiated with the base station 121. The data rate may be negotiated using any suitable control communication, such as Radio Resource Control (RRC) signaling, a Media Access Control (MAC) layer Control Element (CE), or a Physical Uplink Control Channel (PUCCH). The user equipment 110 can detect a trigger event, such as a value of a thermal parameter or a battery-capacity parameter exceeding, or falling below, a threshold. In response to the trigger event, the user equipment 110 can determine a data-rate scaling factor and transmit the data-rate scaling factor to the base station 121. The base station 121 receives the data-rate scaling factor from the user equipment 110 and determines an adjusted data rate that is provided to the user equipment 110.

The base station 121 uses the data-rate scaling factor to determine the adjusted data rate (e.g., by adjusting the negotiated data rate based on the data-rate scaling factor). For example, the data-rate scaling factor can be a fraction of the original negotiated data rate, such as 1.1, 1.0, 0.8, 0.75, or 0.4. Thus, a data-rate scaling factor of “0.75” would result in an adjusted data rate that is 75 percent of the negotiated data rate and a data-rate scaling factor of “1.0” would leave the negotiated data rate unchanged or restore the adjusted data rate to the original data rate. In other cases, the data-rate scaling factor is a percentage of the adjusted data rate and can be used to further adjust the adjusted data rate up or down.

In some implementations, (e.g., when no uplink has been granted to the user equipment) the user equipment 110 transmits the data-rate scaling factor to the base station 121 via a Random Access Channel (RACH) or a Physical Random Access Channel (PRACH). If an uplink has been granted, the user equipment 110 can transmit the data-rate scaling factor to the base stations 120 via RRC signaling, a MAC CE, a PUCCH, and so forth. The described techniques may be performed by the user equipment 110 and the base station 121 using applications or modules described herein, such as the data-rate manager 220 and/or the resource manager 266, respectively.

### Example Methods

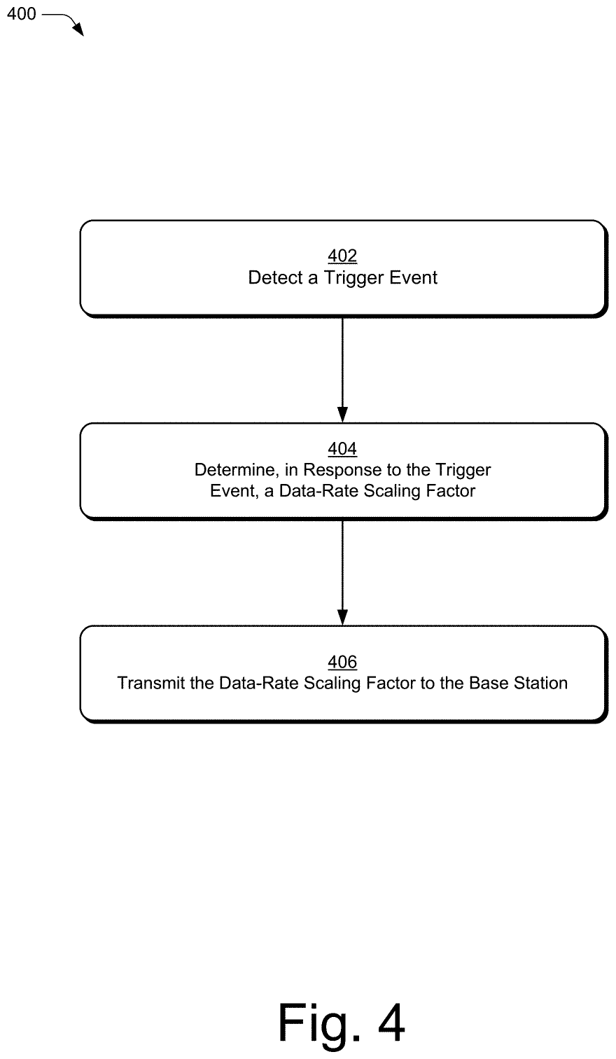

Example methods 400 and 500 are described with reference to FIGS. 4-7 in accordance with one or more aspects of fast data-rate scaling. The order in which the method blocks are described are not intended to be construed as a limitation, and any number of the described method blocks can be skipped or combined in any order to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 4 illustrates example method(s) 400 for fast data-rate scaling as generally related to adjusting a data rate, negotiated between the user equipment and the base station, at which the user equipment is operating. The adjustment is based at least in part on a data-rate scaling factor that is transmitted from the user equipment 110 to the base station 121 in response to an occurrence of a trigger event.

At block 402, the user equipment detects a trigger event. Generally, the trigger event indicates a condition or state of the user equipment that may be addressed by adjusting the data rate. For example, the trigger event may occur when a thermal parameter of the user equipment 110 exceeds a thermal threshold, such as a particular temperature or a percentage of a maximum safe operating temperature of the user equipment 110 (e.g., 90, 75, or 60 percent). The trigger event may also or instead be related to a remaining battery-capacity level of the user equipment 110. For example, the trigger event may occur if a remaining battery capacity falls below a capacity threshold. The threshold may be based on a percentage of battery capacity remaining (e.g., 40, 25, or 15 percent of battery capacity) or on an estimated or calculated duration of remaining battery life (e.g., 90, 60, or 30 minutes).

Additionally or alternatively, the trigger event may be related to a time interval or a predetermined schedule. For example, the trigger event may occur according to a predetermined schedule (e.g., at a set time such as 9:00 PM or 1:00 AM, or at set intervals, such as every 60 or 90 minutes) or at predetermined intervals after occurrence of a thermal- or battery-capacity-based trigger event as described above (e.g., every 10, 5, or 3 minutes after the trigger event) until the thermal parameter or battery-capacity level no longer exceeds the trigger event threshold. The user equipment 110 may detect the trigger event in any of a variety manners. For example, the user equipment 110 may communicate with either or both of the thermal manager 216 and the power manager 218 to detect thermal- or power-related trigger events.

At block 404, in response to the trigger event, the user equipment determines a data-rate scaling factor. For example, when the user equipment 110 detects the trigger event (e.g., a temperature of the user equipment 110 exceeds the thermal threshold or the battery capacity falls below the capacity threshold), the user equipment 110 determines a data-rate scaling factor, such as 0.8, that can reduce the data rate and may mitigate the conditions that caused the occurrence of the trigger event. Generally, the data-rate scaling factor is a parameter that can be used to adjust the data rate provided by the base station 121. More specifically, the data-rate scaling factor may be a fraction of the data rate or a fraction of the adjusted data rate. For example, the data-rate scaling factor may be a fraction of the original, negotiated, data rate, such as 1.0, 0.8, 0.75, or 0.4. In other cases, the data-rate scaling factor may be a percentage of the adjusted data rate and can be used to further adjust the adjusted data rate up or down.

Additionally or alternatively, the user equipment 110 may determine the data-rate scaling factor based on an amount by which the thermal parameter exceeds the thermal threshold or an amount by which the remaining battery-capacity level falls below the capacity threshold. Continuing the example above, in which the temperature of the user equipment 110 exceeds the thermal threshold, the data-rate scaling factor may be determined based on an amount by which the thermal threshold is exceeded. Thus, if the temperature exceeds the thermal threshold by, for example, fewer than five degrees, the data-rate scaling factor may be determined to be 0.8. In contrast, if the temperature exceeds the thermal threshold by, for example, more than ten degrees, the data-rate scaling factor may be determined to be 0.4.

At block 406, the user equipment transmits the data-rate scaling factor to the base station. For example, the user equipment 110 may transmit the data-rate scaling factor to the base station 121, which is providing the negotiated data rate. The user equipment 110 may transmit the data-rate scaling factor in any suitable manner, such as via a Random Access Channel (RACH) or a Physical Random Access Channel (PRACH). If the trigger event occurs while an uplink has been granted, the user equipment 110 can also transmit the data-rate scaling factor to the base station 121 via RRC signaling, a MAC CE, a PUCCH, and so forth. Further, the data-rate scaling factor may be signaled on a per carrier basis, on a per band basis, and/or on a per band per band-combination basis.

Transmitting the data-rate scaling factor can cause the base station to provide an adjusted data rate that is based, at least in part, on the data-rate scaling factor. For example, the base station 121 can provide an adjusted data rate to the user equipment 110 that is based, at least in part, on the data-rate scaling factor transmitted by the user equipment 110. The user equipment 110 can then operate at the adjusted data rate. The base station 121 may provide the data rate using any suitable method, such as by RRC signaling.

In some implementations, the data-rate scaling factor may be transmitted from the user equipment to the base station via another base station, using an inter-base station interface. For example, the base station 121 that provides the adjusted data rate may be a 5G NR base station that includes an inter-base station interface 268, such as an Xn interface. The user equipment 110 may transmit the data-rate scaling factor to the other base station (e.g., the other base station 122), which relays the data-rate scaling factor to the base station 121. The base station 121 then provides the adjusted data rate to the user equipment 110. The Xn interface can allow the 5G NR base station 121 to receive the data-rate scaling factor from the base station 122, which may be any suitable base station 120 (e.g., another 5G NR base station or a 3GPP LTE base station).

In some implementations, the user equipment 110 may transmit the data-rate scaling factor to one or more of the base stations 120 via a supplemental uplink (e.g., a 3GPP LTE uplink). Additionally or alternatively, the user equipment 110 may be connected to an LTE base station 120 (e.g., for signaling and control-plane activity) and also connected to a 5G NR base station 120 (e.g., for data transmission). In this type of dual-connectivity implementation, the user equipment 110 can transmit the data-rate scaling factor to the LTE base station 120 using upper-layer signaling, such as RRC signaling or a MAC control element. The LTE base station 120 can then transmit the data-rate scaling factor to the 5G NR base station 120 using, for example, the inter-base station interface 268. Because the user equipment 110 typically uses less power when using a narrower-band connection (such as the connection to the LTE base station 120), this type of dual-connectivity implementation may be advantageous in a situation in which the trigger event occurs while the user equipment already has been granted uplink to the LTE base station.

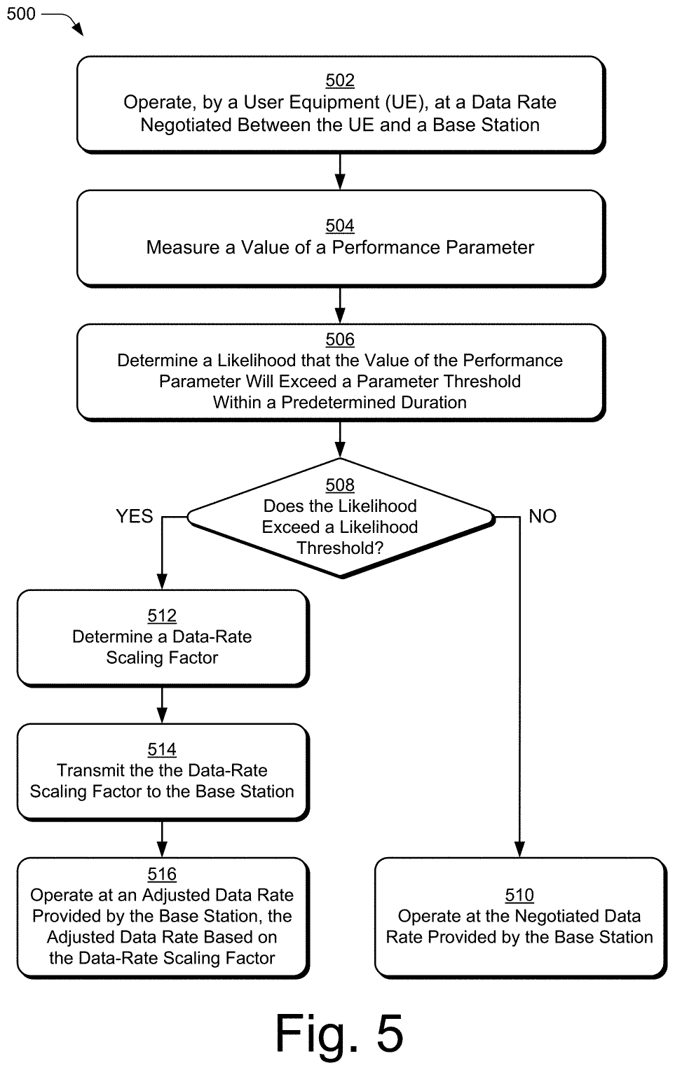

FIG. 5 illustrates example method(s) 500 for fast data-rate scaling as generally related to adjusting, based on a prediction of a trigger event occurring, a data rate the base stations 120 provide to the user equipment 110 using a data-rate scaling factor that is transmitted from the user equipment 110 to the base stations 120.

At block 502, a user equipment operates at a date rate that is negotiated between the user equipment and the base station. For example, the user equipment 110 operates at the data rate that is negotiated between the user equipment 110 and the base station 121 using, for example, RRC signaling or a MAC control element.

At block 504, the user equipment measures a value of a performance parameter. Generally, the performance parameter is a parameter that has a range of values, some of which can affect operating condition limits of the user equipment (e.g., a temperature or battery state of the user equipment). The performance parameter can be targeted for measurement and its value can be predicted or projected over time using, for example, machine learning techniques, historical data, or other conventional prediction techniques. For example, the user equipment 110 may measure, or obtain measurements of, a thermal parameter of the user equipment 110, a battery-capacity parameter of the user equipment 110, and so forth. The measurements may be taken or provided by any suitable source, such as the thermal manager 216 or the power manager 218, as described above.

At block 506, the user equipment determines (or is provided with) a likelihood that the value of the performance parameter will exceed a parameter threshold within a predetermined duration. The parameter threshold may be any suitable threshold value related to the performance parameter, such as such as an operating temperature limit or a battery-capacity limit. The predetermined duration may be any suitable duration, such as a selected interval (e.g., five, ten, or fifteen minutes) or a duration prior to a known or estimated event. For example, the user equipment 110 can obtain current or near-current values for a temperature parameter and, using an appropriate technique, project the value of the parameter over a next ten minute interval or over a duration prior to a next scheduled or estimated uplink grant. The user equipment 110 can compare the projected values to, for example, a percentage of a maximum safe operating temperature of the user equipment 110 (e.g., the threshold), such as 90, 75, or 60 percent of the maximum safe operating temperature.

At block 508, the user equipment determines whether the likelihood that the value of the performance parameter will exceed the parameter threshold within the duration exceeds a likelihood threshold. If the likelihood that the value of the performance parameter will exceed the threshold within the duration does not exceed the likelihood threshold, the user equipment continues to operate at the negotiated data rate, at block 510. If the likelihood that the value of the performance parameter will exceed the threshold within the duration exceeds the likelihood threshold, the user equipment determines a data-rate scaling factor, at block 512. For example, the user equipment 110 determines whether the likelihood that the value of the performance parameter will exceed the threshold within the duration exceeds a likelihood threshold. If the likelihood that the value of the performance parameter will exceed the parameter threshold within the duration does not exceed the likelihood threshold, the user equipment 110 continues to operate at the negotiated data rate. If the likelihood that the value of the performance parameter will exceed the threshold within the duration exceeds the likelihood threshold, the user equipment 110 determines a data-rate scaling factor. The likelihood threshold may be any suitable threshold, such as a 95, 90, or 80 percent likelihood.

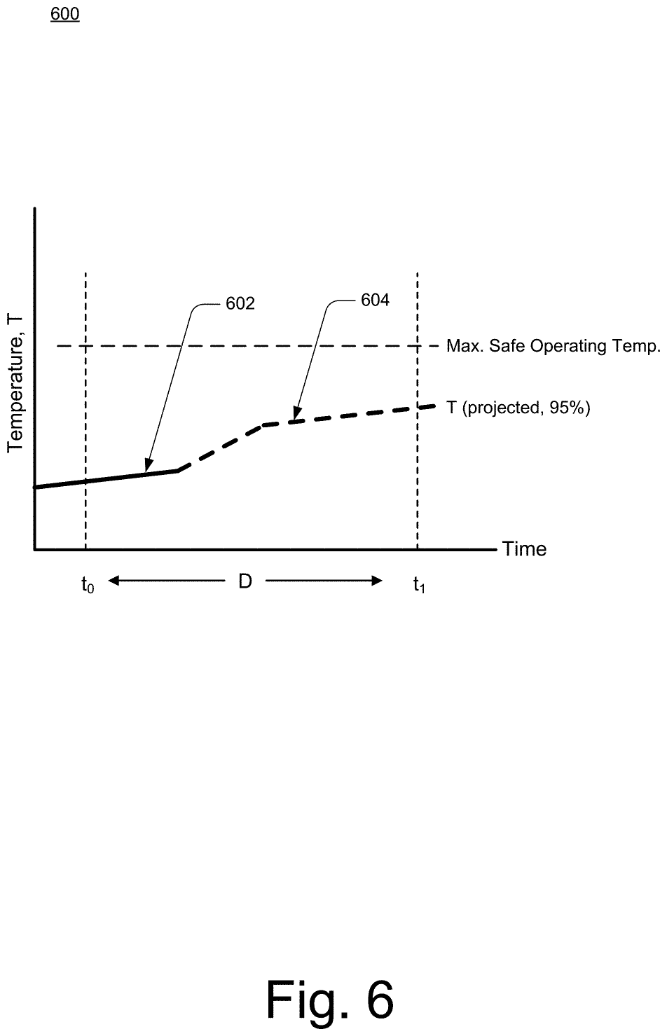

Consider FIG. 6, which illustrates additional details 600 of the example method 500. In FIG. 6, time is depicted along a horizontal dimension as the abscissa axis, and a value of the performance parameter (temperature, T, in this example) is depicted along the vertical dimension as the ordinate axis. A horizontal dashed line labeled “Max. Safe Operating Temp.” represents the parameter threshold for the value of T. A time duration, D, is shown on the time axis between a time to and a time ti, shown by vertical dashed lines. Measurements of the values of T are shown by a solid line 602. Projections of the values of T are shown as a dashed line 604. In the example of FIG. 6, assume that the likelihood threshold is 90 percent and the projected values indicate a 95 percent likelihood that the performance parameter will not exceed the parameter threshold within in the duration. The user equipment 110 can use the information depicted in the example graph to determine that the likelihood the value of T will not exceed the threshold within the duration (95 percent, as noted above) does not exceed the likelihood risk threshold (90 percent, as noted above). Note that in this case, exceeding the likelihood threshold means that the likelihood is less than the likelihood threshold. Thus, the user equipment 110 continues to operate at the negotiated data rate provided by the base station 121, as shown at block 510.

Returning to FIG. 5, at block 512, the user equipment determines a data-rate scaling factor. For example, when the user equipment 110 determines that the likelihood that the value of T will not exceed the parameter threshold within the duration does not exceed the likelihood threshold, the user equipment 110 determines a data-rate scaling factor. As noted, the data-rate scaling factor may be a fraction of the data rate negotiated with the base station 121 or, if the data rate has already been adjusted, the data-rate scaling factor can be a fraction of the adjusted data rate.

At block 514, the user equipment transmits the data-rate scaling factor to the base station. For example, the user equipment 110 may transmit the data-rate scaling factor to the base station 121 via a RACH resource or a PRACH resource. As noted, if an uplink has been granted, the user equipment 110 can also transmit the data-rate scaling factor to the base station 121 via RRC signaling, a MAC control element, a PUCCH, and so forth.

At block 516, the user equipment operates at an adjusted date rate. For example, the user equipment 110 may operate at an adjusted data rate that is provided by the base station 121 and that is based, at least in part, on the data-rate scaling factor transmitted by the user equipment 110.

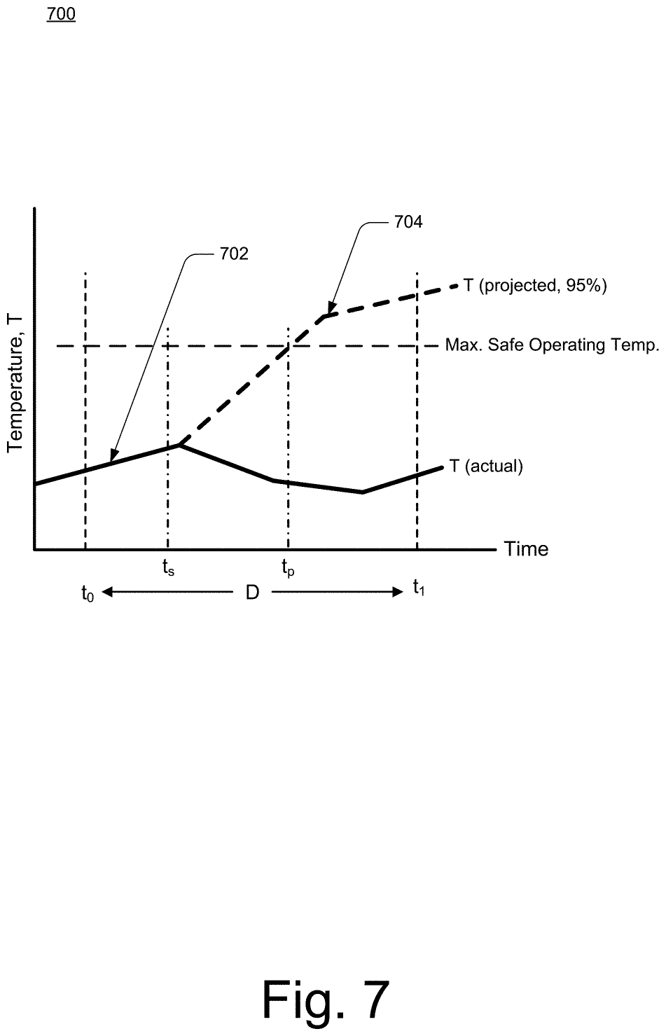

Consider FIG. 7, which illustrates additional details 700 of the example method 500. In FIG. 7, time is depicted along a horizontal dimension as the abscissa axis, and a value of the performance parameter (temperature, T, in this example) is depicted along the vertical dimension as the ordinate axis. A horizontal dashed line labeled “Max. Safe Operating Temp.” represents the parameter threshold for the value of T. A time duration, D, is shown on the time axis between a time to and a time ti, shown by vertical dashed lines. Measurements of values of T are shown by a solid line 702. Projections of values of T are shown as a dashed line 704. In the example of FIG. 7, assume that the likelihood threshold is 90 percent and the projected values indicate a 95 percent likelihood that the performance parameter will exceed the parameter threshold within in the duration.

The user equipment 110 can use the information depicted in the example graph to determine that the likelihood the value of T will exceed the threshold within the duration (95 percent, as noted above) will exceed the likelihood threshold (90 percent, as noted above). For example, the dashed line 704 shows that the value of T is projected to exceed the parameter threshold value at a time tₚ, which is within the duration, D. In response to determining the likelihood that the value of T will exceed the parameter threshold within the duration exceeds the likelihood threshold, the user equipment 110 determines a data-rate scaling factor and transmits the data-rate scaling factor to the base station 121 at a time, tₛ, that is prior to the time tₚ. In this way, the data-rate scaling factor may be used to manage performance parameters, such as the operating temperature of the user equipment 110. For example, as shown in FIG. 7, after the data-rate scaling factor is transmitted to the base stations 120, the actual measured values of T (shown by the solid line 702) do not exceed the safe operating temperature threshold.

Although aspects of data-rate scaling for 5G NR user equipment have been described in language specific to features and/or methods, the subject of the appended claims is not necessarily limited to the specific features or methods described. Rather, the specific features and methods are disclosed as example implementations of the fast data-rate scaling, and other equivalent features and methods are intended to be within the scope of the appended claims. Further, various different aspects are described, and it is to be appreciated that each described aspect can be implemented independently or in connection with one or more other described aspects.

What is claimed is:

1. A method for adjusting a data rate at which a user equipment (UE) is operating, the method comprising:
detecting a trigger event;
in response to the trigger event, determining a data-rate scaling factor;
transmitting the data-rate scaling factor to a base station that is providing the data rate negotiated between the UE and the base station, the transmitting being effective to cause the base station to provide an adjusted data rate that is based at least in part on the data-rate scaling factor.

2. The method of claim 1, wherein transmitting the data-rate scaling factor to the base station further comprises transmitting the data-rate scaling factor to the base station while the UE does not have an uplink grant from the base station.

3. The method of claim 2, wherein transmitting the data-rate scaling factor to the base station further comprises transmitting the data-rate scaling factor to the base station via a Random Access Channel (RACH) or a Physical Random Access Channel (PRACH).

4. The method of claim 1, wherein transmitting the data-rate scaling factor to the base station further comprises transmitting the data-rate scaling factor to the base station while the UE has an uplink grant from the base station.

5. The method of claim 4, wherein transmitting the data-rate scaling factor to the base station further comprises transmitting the data-rate scaling factor to the base station via Radio Resource Control (RRC) signaling, a Media Access Control (MAC) layer Control Element (CE), or a Physical Uplink Control Channel (PUCCH).

6. The method of claim 1, wherein transmitting the data-rate scaling factor to the base station further comprises transmitting the data-rate scaling factor to the base station via a supplementary uplink and wherein the supplementary uplink is a Third Generation Partnership Project (3GPP) Long-Term Evolution (LTE) uplink.

7. The method of claim 1, wherein the trigger event is:
a thermal parameter of the UE exceeding a thermal threshold;
a remaining battery capacity falling below a capacity threshold;
a predetermined time interval; or
a predetermined schedule.

8. The method of claim 1, wherein:
the data-rate scaling factor is a fraction of the negotiated data rate; or
the data-rate scaling factor is a fraction of the adjusted data rate.

9. A user equipment (UE), comprising:
a radio frequency (RF) transceiver; and
a processor and memory system to implement a data-rate manager application configured to:
detect a trigger event;
determine, in response to the trigger event, a data-rate scaling factor for an operating data rate; and
transmit, using the RF transceiver, the data-rate scaling factor to a base station;
receive, from the base station, an adjusted data rate that is based, at least in part, on the data-rate scaling factor; and
cause the UE to operate at the adjusted data rate.

10. The UE of claim 9, wherein the data-rate manager application is further configured to transmit the data-rate scaling factor to the base station while the UE does not have an uplink grant from the base station.

11. The UE of claim 10, wherein the data-rate manager application is further configured to transmit the data-rate scaling factor to the base station via a Random Access Channel (RACH) or a Physical Random Access Channel (PRACH).

12. The UE of claim 9, wherein the data-rate manager application is further configured to transmit the data-rate scaling factor to the base station while the UE has an uplink grant from the base station.

13. The UE of claim 12, wherein the data-rate manager application is further configured to transmit the data-rate scaling factor to the base station via Radio Resource Control (RRC) signaling, a Media Access Control (MAC) layer Control Element (CE), or a Physical Uplink Control Channel (PUCCH).

14. The UE of claim 9, wherein:
the base station is a first base station; and
the data-rate manager application is further configured to transmit the data-rate scaling factor to the first base station by transmitting the data-rate scaling factor to a second base station, effective to relay the data-rate scaling factor to the first base station, the second base station being a 3rd Generation Partnership Project (3GPP) Long-Term Evolution (LTE) base station.

15. The UE of claim 9, wherein the trigger event is:
a thermal parameter of the UE exceeding a thermal threshold;
a remaining battery capacity falling below a capacity threshold;
a predetermined time interval; or
a predetermined schedule.

16. The UE of claim 9, wherein the data-rate scaling factor is:
a fraction of the negotiated data rate; or
a fraction of the adjusted data rate.

17. A base station, comprising:
a radio frequency (RF) transceiver; and
a processor and memory system to implement a resource manager application configured to:
negotiate a data rate with a user equipment (UE);
provide the data rate to the UE;
receive, via the RF transceiver, a data-rate scaling factor from the UE;
determine, based at least in part on the data-rate scaling factor, an adjusted data rate; and
provide the adjusted data rate to the UE, effective to cause the UE to operate at the adjusted data rate.

18. The base station of claim 17, wherein the resource manager application is further configured to:
allocate air interface resources; and
in response to receiving the data-rate scaling factor, reallocate air interface resources.

19. The base station of claim 17, wherein the resource manager application is further configured to:
receive the data-rate scaling factor from the UE via a Random Access Channel (RACH) or a Physical Random Access Channel (PRACH); or
receive the data-rate scaling factor from the UE via Radio Resource Control (RRC) signaling, a Media Access Control (MAC) layer Control Element (CE), or a Physical Uplink Control Channel (PUCCH).

20. The base station of claim 17, wherein the base station is a Fifth Generation New Radio (5G NR) base station including an Xn interface, and wherein the resource manager application is further configured to receive the data-rate scaling factor via the Xn interface from either a 3GPP LTE base station or another 5G NR base station.
